(19) United States
(12) Patent Application Publication
(10) Pub. No.: US 2026/0084228 A1
(43) Pub. Date: Mar. 26, 2026

(54) SAW BLADE

(71) Applicant: MILWAUKEE ELECTRIC TOOL CORPORATION, Brookfield, WI (US)

(72) Inventors: Austin C. HOWSE, Milwaukee, WI (US); Andrew J. CHARTIER, Sussex, WI (US); Alexander C. GHOUSE, Ixonia, WI (US); Jiancheng LAN, Dongguan City (CN); Yangchun JIANG, Hangzhou City (CN)

(21) Appl. No.: 19/312,434

(22) Filed: Aug. 28, 2025

(30) Foreign Application Priority Data
Sep. 26, 2024 (CN) 202422366794.5

(51) Int. Cl. B23D 61/02

(52) U.S. Cl. CPC B23D 61/025

(57) ABSTRACT

A saw blade includes a body having a center and a circumferential edge. The saw blade also includes an arbor disposed at the center of the body, the arbor defining a first aperture, a second aperture, and a third aperture circumferentially spaced from each other about the center of the body and configured to receive alignment protrusions of a tool, the first aperture having a first diameter, the second aperture having a second diameter that is different than the first diameter. The saw blade further includes a bore formed in the arbor between the first aperture, the second aperture, and the third aperture, the bore configured to receive an output shaft of the tool. The saw blade also includes a cutting edge extending from the circumferential edge of the body.

### CROSS-REFERENCE TO RELATED APPLICATIONS

This application claims priority to Chinese Utility Model Application No. 202422366794.5, filed Sep. 26, 2024, the entire contents of which are incorporated herein by reference.

### FIELD OF THE INVENTION

The present disclosure relates to saw blades.

### BACKGROUND OF THE INVENTION

Saw blades, such as circular saw blades, table saw blades, chop saw blades, reciprocating saw blades, hand saw blades, and/or the like, are used to remove material from a workpiece to create a cut therein.

### SUMMARY OF THE INVENTION

In some aspects, the techniques described herein relate to a saw blade including a body having a center and a circumferential edge; an arbor disposed at the center of the body, the arbor defining a first aperture, a second aperture, and a third aperture circumferentially spaced from each other about the center of the body and configured to receive alignment protrusions of a tool, the first aperture having a first diameter, the second aperture having a second diameter that is different than the first diameter; a bore formed in the arbor between the first aperture, the second aperture, and the third aperture, the bore configured to receive an output shaft of the tool; and a cutting edge extending from the circumferential edge of the body.

In some aspects, the techniques described herein relate to a saw blade, wherein the third aperture has a third diameter that is different than the second diameter.

In some aspects, the techniques described herein relate to a saw blade, wherein the third diameter is the same as the first diameter.

In some aspects, the techniques described herein relate to a saw blade, wherein the second diameter is greater than the first diameter.

In some aspects, the techniques described herein relate to a saw blade, wherein the first diameter is between 3 millimeters and 8 millimeters, and wherein the second diameter is between 4 mm and 9 mm.

In some aspects, the techniques described herein relate to a saw blade, wherein the bore has a diameter between 25 mm and 31 mm.

In some aspects, the techniques described herein relate to a saw blade, wherein the bore has a diameter that is greater than the first diameter and that is greater than the second diameter.

In some aspects, the techniques described herein relate to a saw blade, wherein a ratio of the diameter of the bore to the first diameter is between 3 and 10.5, and wherein a ratio of the diameter of the bore to the second diameter is between 2.5 and 8.

In some aspects, the techniques described herein relate to a saw blade, wherein the first aperture, the second aperture, and the third aperture are equally circumferentially spaced from each other.

In some aspects, the techniques described herein relate to a saw blade, wherein the first aperture is spaced a first radial distance from the center of the body, and wherein the second aperture is spaced a second radial distance from the center of the body that is different than the first radial distance.

In some aspects, the techniques described herein relate to a saw blade, wherein the third aperture is spaced a third radial distance from the center of the body that is different than the first radial distance.

In some aspects, the techniques described herein relate to a saw blade, wherein the third radial distance is the same as the second radial distance.

In some aspects, the techniques described herein relate to a saw blade, wherein the first aperture is spaced a first radial distance from the center of the body, the second aperture is spaced a second radial distance from the center of the body that is different than the first radial distance, the third aperture has a third diameter and is spaced a third radial distance from the center of the body, the third diameter is the same as the first diameter, and the third radial distance is the same as the second radial distance.

In some aspects, the techniques described herein relate to a saw blade including a body constructed of a first material and having a center and a circumferential edge; an arbor disposed at the center of the body; a bore formed in the arbor, the bore configured to receive an output shaft of a tool; a plurality of cutting teeth extending from the circumferential edge of the body; and a plurality of inserts coupled to the plurality of cutting teeth, each insert constructed of a second material that is different than the first material and including a first side and a second side opposite the first side, the first and second sides defining a width of the insert, a cutting edge extending between the first and second sides, a rake face adjacent the cutting edge, the rake face defining a notch in the insert, a planar wall extending from the rake face toward the body, and a relief face extending from the cutting edge, the relief face having a chamfer that extends along at least one of the first and second sides and over at least half of the width of the insert.

In some aspects, the techniques described herein relate to a saw blade, wherein the rake face of at least some inserts includes a curved wall and a planar wall that define the notch.

In some aspects, the techniques described herein relate to a saw blade, wherein the rake face of at least some inserts includes a first planar wall and a second planar wall that define the notch.

In some aspects, the techniques described herein relate to a saw blade, wherein the chamfer of at least some inserts is formed by a single chamfered wall extending from a horizontal wall.

In some aspects, the techniques described herein relate to a saw blade, wherein the chamfer of at least some inserts is formed by a first chamfered wall and a second chamfered wall extending in opposite directions from a horizontal wall.

In some aspects, the techniques described herein relate to a saw blade, wherein the first and second sides of at least some inserts taper toward each other as the first and second sides extend away from the cutting edge.

In some aspects, the techniques described herein relate to a saw blade including a body constructed of a first material and having a center and a circumferential edge; an arbor disposed at the center of the body; a bore formed in the arbor, the bore configured to receive an output shaft of a tool; a plurality of cutting teeth extending from the circumferential edge of the body; and a plurality of inserts coupled to the plurality of cutting teeth, each insert constructed of a second material that is different than the first material and including a first side and a second side opposite the first side, a cutting edge extending between the first and second sides, a rake face adjacent the cutting edge, the rake face defining a notch in the insert, a planar wall extending from the rake face toward the body, and a relief face extending from the cutting edge; wherein the cutting edges of the plurality of inserts collectively define a cutting diameter of the saw blade that is between 135 millimeters and 139 millimeters.

Other features and aspects of the invention will become apparent by consideration of the following detailed description and accompanying drawings.

### BRIEF DESCRIPTION OF THE DRAWINGS

FIG. 1 is a side view of a saw blade, according to an embodiment of the present disclosure.

FIG. 2 is an enlarged, side view of a cutting tooth of a plurality of cutting teeth and an insert of a plurality of inserts taken at callout 2-2 of FIG. 1.

FIG. 3 is a front view of a cutting tooth of the plurality of cutting teeth and an insert of the plurality of inserts taken at callout 3-3 of FIG. 1.

FIG. 4 is a front view of a cutting tooth of the plurality of cutting teeth and an insert of the plurality of inserts taken at callout 4-4 of FIG. 1.

FIG. 5 is a top view of the cutting tooth and the insert taken at callout 5-5 of FIG. 1.

FIG. 6 is a top view of the cutting tooth and the insert taken at callout 6-6 of FIG. 1.

FIG. 7 is a side view of a saw blade, according to an embodiment of the present disclosure.

FIG. 8 is an enlarged, side view of a cutting tooth of a plurality of cutting teeth and an insert of a plurality of inserts taken at callout 8-8 of FIG. 7.

FIG. 9 is a front view of a cutting tooth of the plurality of cutting teeth and an insert of the plurality of inserts taken at callout 9-9 of FIG. 7.

FIG. 10 is a front view of a cutting tooth of the plurality of cutting teeth and an insert of the plurality of inserts taken at callout 10-10 of FIG. 7.

FIG. 11 is a front view of a cutting tooth of the plurality of cutting teeth and an insert of the plurality of inserts taken at callout 11-11 of FIG. 7.

FIG. 12 is a top view of the cutting tooth and the insert of taken at callout 12-12 of FIG. 7.

FIG. 13 is a top view of the cutting tooth and the insert of taken at callout 13-13 of FIG. 7.

FIG. 14 is a top view of the cutting tooth and the insert of taken at callout 14-14 of FIG. 7.

FIG. 15 is an exploded perspective view of a saw blade coupled to a tool.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

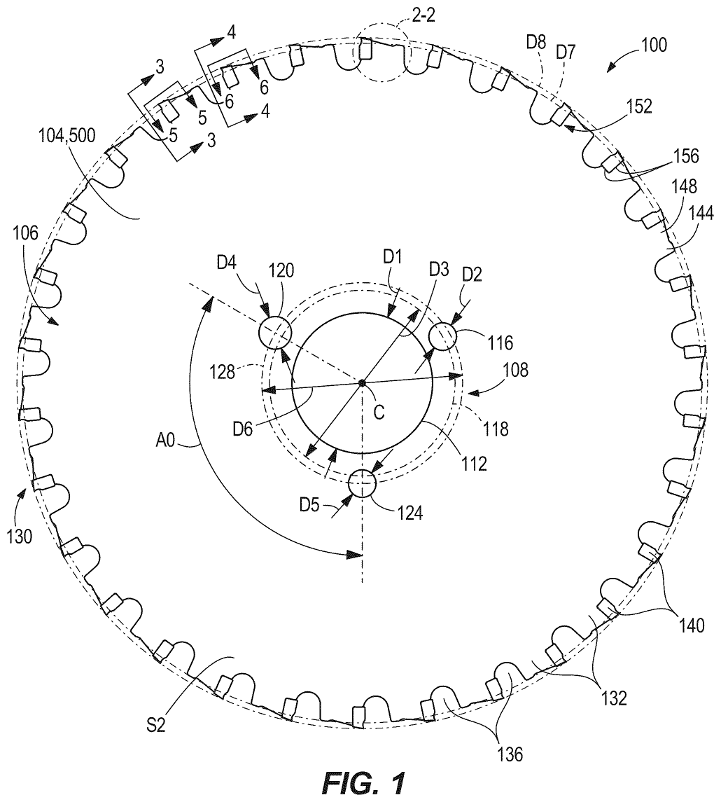

FIG. 1 illustrates a saw blade 100, according to an embodiment of the present disclosure. In the illustrated embodiment, the saw blade 100 is a circular saw blade that is selectively useable with a circular saw, a table saw, a miter saw, or the like. However, in other embodiments, the saw blade 100 can be a different type of saw blade that can be coupled to a corresponding power tool.

As illustrated in FIG. 1, the saw blade 100 includes a core portion or body 104 having a center C and a peripheral or circumferential edge 106, an arbor 108, and a bore 112 formed in the arbor 108 and configured to allow the saw blade 100 to fit on an output shaft of a tool that has a complementary shape to the bore 112. In the illustrated embodiment, the bore 112 extends completely through the body 104 (e.g., a through hole). The bore 112 extends through the center C of the body 104. In the illustrated embodiment, the bore 112 has a circular shape and is configured to fit on a circular shaft. The bore 112 defines a diameter D1. In the illustrated embodiment, the diameter D1 is between 25 millimeter and 31 millimeters. Specifically, the diameter D1 is 28 millimeters. In other embodiments, the bore 112 and shaft may both be another shape, such as a diamond, square, hexagon, semi-circle, and/or the like.

The illustrated arbor 108 defines a first aperture 116, a second aperture 120, and a third aperture 124. In the illustrated embodiment, the first, second, and third apertures 116, 120, 124 extend completely through the body 104 (e.g., a through hole). In other embodiments, the first, second, and third apertures 116, 120, 124 may only extend partially through the body 104 (e.g., a blind hole). The first, second, and third apertures 116, 120, 124 are configured to receive alignment protrusions of the tool to help align the saw blade 100 on the tool and the output shaft. The first, second, and third apertures 116, 120, 124 are separated at a non-zero angle A0. In the illustrated embodiment, the non-zero angle A0 is 120 degrees relative to one another and about the center C. As such, the first, second, and third apertures 116, 120, 124 are each disposed around the center C at 120 degrees relative to one another. In other words, the first, second, and third apertures 116, 120, 124 are equally circumferentially spaced from each other.

The first aperture 116 defines a first diameter D2. In the illustrated embodiment, the first diameter D2 is between 3 millimeters and 8 millimeters. Specifically, the first diameter D2 is 5.5 millimeters. The first aperture 116 is smaller than the bore 112. A ratio of the diameter D1 of the bore 112 to the first diameter D2 is between 3 and 10.5. In the illustrated embodiment, the ratio of the diameter D1 of the bore 112 to the first diameter D2 is about 5. The first aperture 116 is located on a circle 118 with a diameter D3 that is concentric with the bore 112. In the illustrated embodiment, the diameter D3 is 37 millimeters. In other words, a center of the first aperture 116 is radially disposed a first radial distance of 18.5 millimeters from the center C of the body 104. In some embodiments, the diameter D3 of the circle 118 may be between 34 millimeters and 40 millimeters. In such embodiments, the center of the first aperture 116 may be radially disposed a first radial distance between 17 millimeters and 20 millimeters from the center C of the body 104.

The second aperture 120 defines a second diameter D4. The second diameter D4 is a different size than the first diameter D2. In the illustrated embodiment, the second diameter D4 is greater than the first diameter D2. In the illustrated embodiment, the second diameter D4 is between 4 millimeters and 9 millimeters. Specifically, the second diameter D4 is 6.5 millimeters. As such, the second diameter D4 is about 1 mm larger than the first diameter D2. In other words, the second diameter D4 is between 10% and 20% larger than the first diameter D2. The second aperture 120 is also smaller than the bore 112. A ratio of the diameter D1 of the bore 112 to the second diameter D4 is between 2.5 and 8. In the illustrated embodiment, the ratio of the diameter D1 of the bore 112 to the second diameter D4 is about 4.

The third aperture 124 defines a third diameter D5. The third diameter D5 is a different size than the second diameter D4. In the illustrated embodiment, the second diameter D4 is greater than the third diameter D5. In the illustrated embodiment, the third diameter D5 is between 3 millimeter and 8 millimeters. Specifically, the third diameter D5 is 5.5 millimeters. As such, the first diameter D2 and the third diameter D5 are the same size. In other embodiments, the first diameter D2 and the third diameter D5 may be different sizes. The third aperture 124 is also smaller than the bore 112. A ratio of the diameter D1 of the bore 112 to the third diameter D5 is between 3 and 10.5. In the illustrated embodiment, the ratio of the diameter D1 of the bore 11 to the third diameter D5 is about 5.

The second and third apertures 120, 124 are located on a circle 128 having a diameter D6 that is concentric with the bore 112. In other words, the third aperture is radially disposed at the same distance from the center C of the body 104 as the second aperture. In the illustrated embodiment, the diameter D6 is 40 millimeters. In other words, a center of second aperture 120 and a center of the third aperture 124 are located a second radial distance and a third radial distance, respectively, of 20 millimeters from the center C of the body 104. In some embodiments, the diameter D6 is between 37 millimeters and 43 millimeters. In such embodiments, the center of the second aperture 120 and the center of the third aperture 124 may be radially disposed at a second radial distance and a third radial distance, respectively, between 18.5 millimeters and 21.5 millimeters from the center C of the body 104. As such, the second and third apertures 120, 124 are located a different distance than the first aperture 116 from the center C of the body 104. In particular, the second and third apertures 120, 124 are located further than the first aperture 116 from the center C of the body 104. In other embodiments, the second and third apertures 120, 124 may also be located different distances from the center C of the body 104.

The saw blade 100 further includes a cutting edge 130. In the illustrated embodiment, the cutting edge 130 includes a plurality of cutting teeth 132 that are spaced along an outer edge of the body 104 and extend outwardly from the circumferential edge 106. In other embodiments, the cutting edge 130 may have other configurations, such as an abrasive grit or diamond cutting edge. The cutting teeth 132 and the body 104 may be constructed from a variety of materials, such as high carbon steel. In the illustrated embodiment, the cutting teeth 132 are integrally formed as a single piece with the body 104. In other embodiments, the body 104 may be made of bi-metal and the cutting teeth 132 may be formed of high-speed steel that is bonded to the body 104. In other words, the cutting teeth 132 are supported on the body 104. In other embodiments, the saw blade 100 may be made from a variety of materials, such as when a saw blade 100 is a masonry blade. In the illustrated embodiment, all of the cutting teeth 132 are generally the same shape and size, although relative dimensions of each tooth of the cutting teeth 132 could be different in other embodiments. The saw blade 100 includes a plurality of gullets 136 that allows for debris (e.g., chips, chunks, etc.) passage during the cutting operation. Each of the plurality of gullets 136 separate adjacent cutting teeth of the plurality of cutting teeth 132. The saw blade 100 includes a plurality of inserts 140. In the illustrated embodiment, each of the cutting teeth 132 includes one insert 140 that forms at least a part of the cutting teeth 132. In other embodiments, only some of the cutting teeth 132 may include inserts 140.

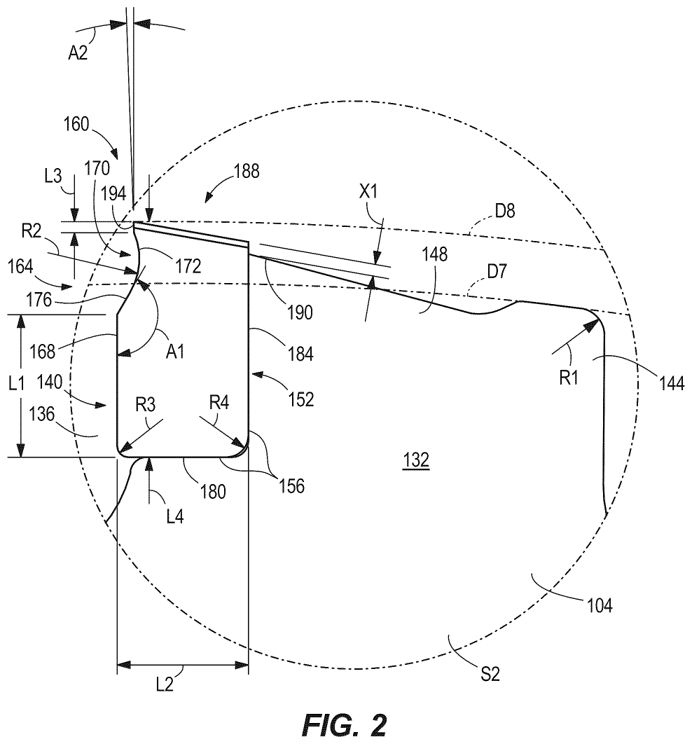

Referring now to FIG. 2, each of the cutting teeth 132 include a heel face 144 and one or more relief surface 148 extending between the insert 140 and the heel face 144. In general, a gullet of the plurality of gullets 136 is formed between the insert 140 and the heel face 144 of adjacent cutting teeth 132. In other words, the plurality of gullets 136 separate adjacent cutting teeth 132. The heel face 144 defines a radius R1. In the illustrated embodiment, the radius R1 is between 0.4 millimeters and 0.6 millimeters. Specifically, the radius R1 is 0.5 millimeters. Each heel face 144 of the plurality of cutting teeth 132 collectively defines a limiting diameter D7. In the illustrated embodiment, the limiting diameter D7 is between 135 millimeters and 137 millimeters. Specifically, the limiting diameter D7 is 136 millimeters. Each of the cutting teeth 132 include a pocket 152 defined by adjacent walls 156 of the cutting tooth 132 joined together at a corner with a radius. The pocket 152 is formed on an opposite side of the cutting tooth 132 from the heel face 144.

With continued reference to FIG. 2, the inserts 140 may be made of carbide (e.g., tungsten carbide) or a similar material. The inserts 140 may be fastened (e.g., welded, brazed, or otherwise secured) to the cutting teeth 132. In some embodiments, only some of the cutting teeth 132 include an insert 140. In other embodiments, the cutting teeth 132 do not include the inserts 140. The inserts 140 may be made of a material that is different than the body 104 and the rest of each cutting teeth 132. In other embodiments, the inserts 140 may be made of a similar material as the body 104 and the rest of the cutting teeth 132, such as high-speed steel.

A single insert of the plurality of inserts 140 is illustrated in FIG. 2. However, each of the plurality of inserts 140 may include the features illustrated with the insert of FIG. 2. Therefore, the insert of FIG. 2 will reflect features of the plurality of inserts 140 and will also be referenced as “the insert 140.” In the illustrated embodiment, the insert 140 includes a cutting edge 160. Each cutting edge 160 extends between opposing sides of the corresponding insert 140. The cutting edges 160 of the inserts 140 collectively define a cutting diameter D8 of the saw blade 100. In the illustrated embodiment, the cutting diameter D8 is between 135 millimeters and 139 millimeters. Specifically, the diameter D8 is 137 millimeters (e.g., 5 ⅜ inches). The saw blade 100 is capable of cutting rebar with a diameter of up to approximately 28.575 millimeters (e.g., 1 ⅛ inches or #10 rebar).

The insert 140 includes a rake face 164 adjacent the cutting edge 160. The rake face 164 extends to a front wall 168. In the illustrated embodiment, the rake face 164 defines a notch 170 in the insert 140. The illustrated notch 170 is defined by a curved wall 172 and a planar wall 176 of the rake face 164. The curved wall 172 and the planar wall 176 are adjacent each other. The curved wall 172 defines a radius R2. In the illustrated embodiment, the radius R2 is between 0.8 millimeters and 1.6 millimeters. Specifically, the radius R2 is 1.2 millimeters. The planar wall 176 is offset from the front wall 168 at a non-zero angle A1. In the illustrated embodiment, the non-zero angle A1 is between 140 degrees and 160 degrees. Specifically, the non-zero angle A1 is 150 degrees.

The illustrated front wall 168 is a planar wall. The front wall 168 has a length L1. In the illustrated embodiment, the length L1 is between 1.8 millimeters to 2.4 millimeters. Specifically, the length L1 is 2.1 millimeters. The insert 140 also includes a bottom wall 180 and a rear wall 184 that are received in the pocket 152. The front wall 168 and the bottom wall 180 are connected at a corner having a radius R3. In the illustrated embodiment, the radius R3 is between 0.1 millimeters and 0.3 millimeters. Specifically, the radius R3 is 0.2 millimeters. The bottom wall 180 has a length L2. In the illustrated embodiment, the length L2 is between 2 millimeters and 2.8 millimeters. Specifically, the length L2 is 2.4 millimeters. The bottom and rear walls 180, 184 are connected at a corner having a radius R4. In the illustrated embodiment, the radius R4 is between 0.5 millimeters and 0.9 millimeters. Specifically, the radius R4 is 0.7 millimeters. The insert 140 also includes a relief face 188, or top wall, extending from the cutting edge 160. The relief face 188 has a distance X1 that is measured from a rearward point of the relief face 188 to a relief surface 190 of the cutting tooth 132. In the illustrated embodiment, the distance X1 is between 0 millimeters and 0.2 millimeters. Specifically, the distance X1 is 0.1 millimeters.

The insert 140 includes a second front wall 194 between the cutting edge 160 and the rake face 164. In particular, the second front wall 194 extends from the cutting edge 160 to the curved wall 172 of the rake face 164. The second front wall 194 is a planar wall and is offset from the front wall 168 at an angle A2. In the illustrated embodiment, the angle A2 is between −2 degrees and 2 degrees. Specifically, the angle A2 is 0 degrees. In other words, the second front wall 194 may be parallel to the front wall 184, but offset from the front wall 184. The second front wall 194 has a length L3. In the illustrated embodiment, the length L3 is between 0.05 millimeters and 0.35 millimeters. Specifically, the length L3 is 0.2 millimeters. The insert 140 has a length L4 measured between the bottom wall 180 and the cutting edge 160. In the illustrated embodiment, the length L4 is approximately 4.5 millimeters.

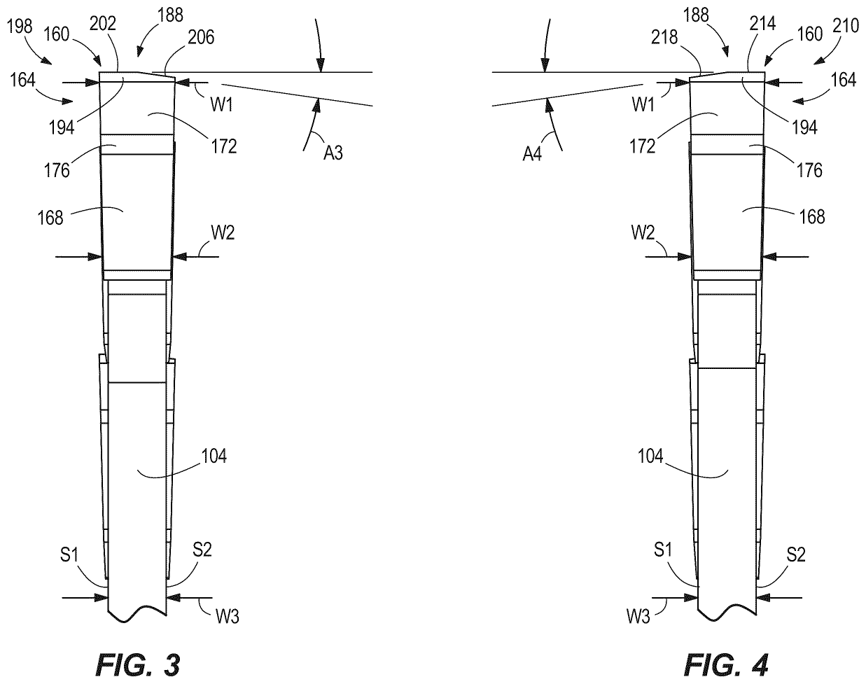

FIG. 3 illustrates an insert 198 of the plurality of inserts 140. The relief face 188 of the insert 198 has a chamfer that extends along one of the sides of the insert 198 and over at least half of a width of the insert 198. In particular, the relief face 188 includes a horizontal wall 202 and a chamfered wall 206. The chamfered wall 206 is angled from the horizontal wall 202 at a non-zero angle A3 and forms the chamfer. In the illustrated embodiment, the non-zero angle A3 is between 6 degrees and 10 degrees. Specifically, the non-zero angle A3 is 8 degrees.

The insert 198 defines a width W1 proximal to the cutting edge 160. In the illustrated embodiment, the width W1 is between 1.5 millimeters and 1.7 millimeters. Specifically, the width W1 is 1.6 millimeters. In some embodiments, the width of the insert 198 is not uniform. For example, the illustrated width tapers between the bottom wall 180 and the relief face 188. For instance, the insert 198 defines a width W2 that is proximal to the bottom wall 180. In other words, the width of the insert 198 decreases from the cutting edge 160 to the bottom wall 180. In the illustrated embodiment, the difference between the width W1 and the W2 is between 0.1 millimeters and 0.28 millimeters. In some embodiments, the width of the insert 198 is larger proximal to the second front wall 194 relative to the bottom wall 180. The body 104 of the saw blade 100 defines a width W3. The width W3 of the body 104 is less than the width W1 of the insert 198. In the illustrated embodiment, the width W3 is between 1 millimeter and 1.4 millimeters. Specifically, the width W3 is 1.2 millimeters.

FIG. 4 illustrates an insert 210 of the plurality of inserts 140. The relief face 188 of the insert 210 has a chamfer that extends along another of the sides of the insert 210 and over at least half of a width of the insert 198. In particular, the relief face 188 includes a horizontal wall 214 and a chamfered wall 218. The chamfered wall 218 is angled from the horizontal wall 214 at a non-zero angle A4. In the illustrated embodiment, the non-zero angle A4 is between 6 degrees and 10 degrees. Specifically, the non-zero angle A4 is 8 degrees. The insert 210 defines the width W1.

A difference between insert 198 and the insert 210 is the position of horizonal wall (e.g., horizontal walls 202, 214) and the chamfered walls (e.g., walls 206, 218) relative to a first side S1 of the body 104 (or insert 198, 210) and a second side S2 of the body 104 (or insert 198, 210). For instance, the horizontal wall 202 is proximal to the first side S1 and the chamfered wall 206 is proximal to the second side S2 for the insert 198. In contrast, the horizontal wall 214 is proximal to the first side S2 and the chamfered wall 218 is proximal to the second side S1.

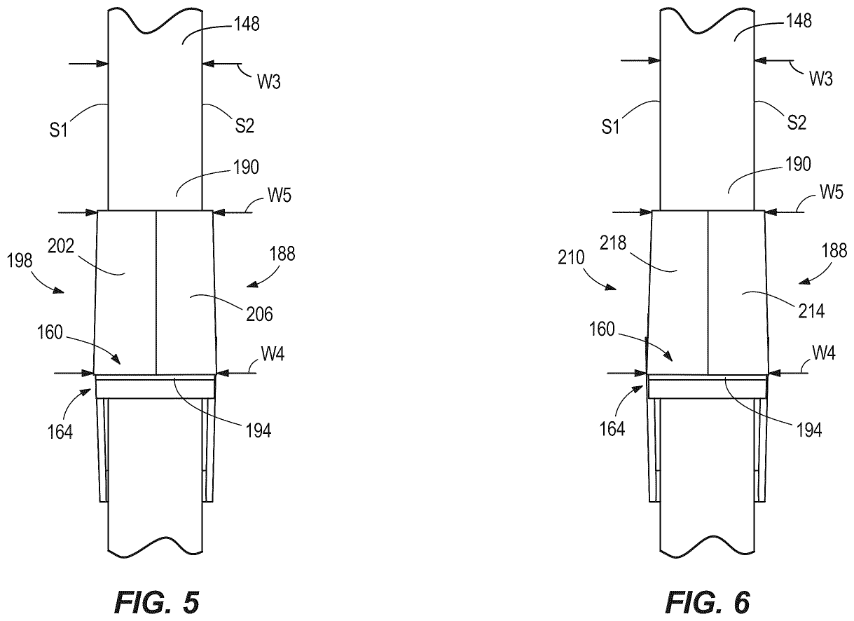

FIG. 5 illustrates the insert 198 defining a width W4 proximal to the rake face 164 and defining a width W5 proximal to the rear wall 184. In the illustrated embodiment, the width W4 is between 1.3 millimeters and 1.9 millimeters. Specifically, the width W is 1.6 millimeters. The difference between the widths W4, W5 is between 0.06 millimeters and 0.16 millimeters. In other words, the width of the insert 198 is tapered between the rake face 164 and the rear wall 184, or the width of the inset is tapered 198 is tapered as it extends away from the cutting edge 160. FIG. 6 illustrates that the insert 210 is also tapered from the rake face 164 to the rear wall 184. In the illustrated embodiment, the difference in widths W4 and W5 of the insert 210 is the same as the insert 198. In other embodiments, the difference in widths W4 and W5 of the insert 210 is different than the insert 198.

Referring back to FIG. 1, the plurality of inserts 140 is a collection of the inserts 198, 210. In the illustrated embodiment, the plurality of inserts 140 alternates between the insert 198 and the insert 210. In other words, a cutting tooth 132 with the insert 198 is flanked by adjacent cutting teeth 132 each having the insert 210. In some embodiments, the plurality of inserts 140 includes different arrangements of the inserts 198, 210.

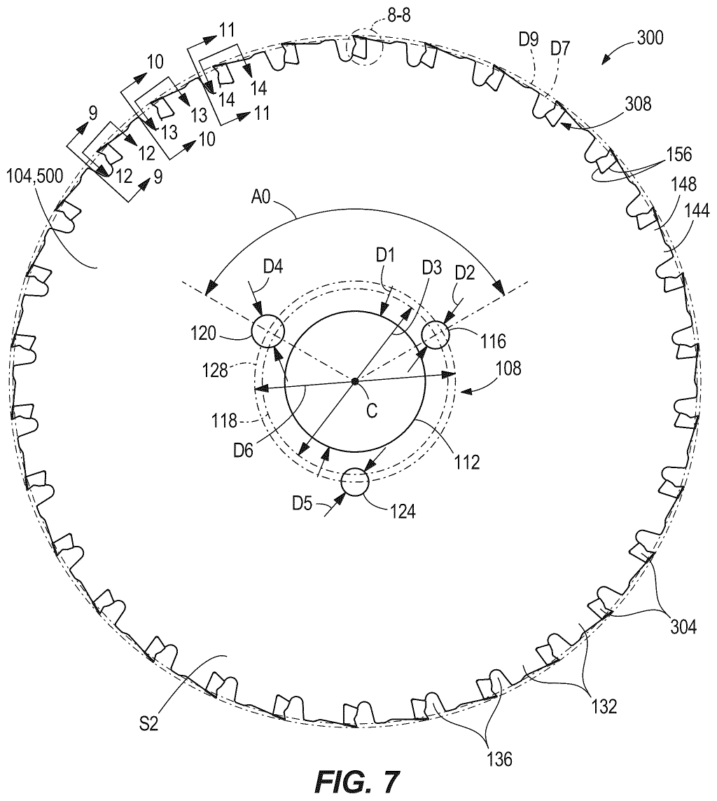

FIG. 7 illustrates another embodiment of a saw blade 300. The saw blade 300 is similar to the saw blade 100 with like features as the saw blade 100 being identified with like reference numerals. Only differences between the saw blades 100, 300 will be discussed. Reference is made to the description of the saw blade 100 above for description of features of the saw blade 300 not explicitly included below.

The saw blade 300 includes a plurality of inserts 304 that are received by the plurality of cutting teeth 132. The cutting teeth 132 each include a pocket 308 having complementary geometry to that of an insert of the plurality of inserts 304. The pocket 308 is different from the pocket 152 in the fact that it includes the corresponding geometry to receive an insert of the plurality of inserts 304 rather than an insert of the plurality of inserts 140.

The inserts 304 may be made of carbide (e.g., tungsten carbide) or a similar material in the illustrated embodiment. The inserts 304 may be fastened (e.g., welded, brazed, or otherwise secured) to the cutting teeth 132. In some embodiments, only some of the cutting teeth 132 include an insert 304. In other embodiments, the cutting teeth 132 do not include the inserts 304. The inserts 304 may be made of a material that is different than the body 104 and the rest of each cutting teeth 132. In other embodiments, the inserts 304 are made of a similar material as the body 104 and the rest of the cutting teeth 132, such as high-speed steel.

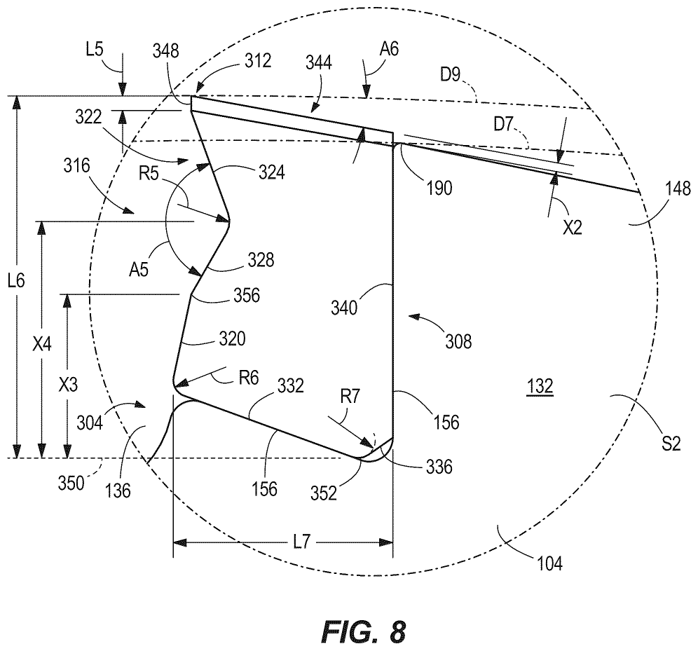

A single insert of the plurality of inserts 304 is illustrated in FIG. 8. However, each of the plurality of inserts 304 may include the features illustrated with the insert of FIG. 8. Therefore, the insert of FIG. 8 will reflect the features of the plurality of inserts 304 and will also be references as “the insert 304.” In the illustrated embodiment, the insert 304 includes a cutting edge 312. Each cutting edge 312 extends between opposing sides of the corresponding insert 304. The cutting edges 312 of the inserts 304 collectively define a cutting diameter D9 of the saw blade 300. In the illustrated embodiment, the cutting diameter D9 is between 135 millimeters and 139 millimeters. Specifically, the diameter D9 is 137 millimeters (e.g., 5 ⅜ inches). The saw blade 300 is capable of cutting rebar with a diameter of up to approximately 28.575 millimeters (e.g., 1 ⅛ inches or #10 rebar).

The insert 304 includes a rake face 316 adjacent the cutting edge 312. The rake face 316 extends to a front wall 320. In the illustrated embodiment, the rake face 316 defines a notch 322 in the insert 304. The illustrated notch 322 is defined by a first planar wall 324 and a second planar wall 328 of the rake face 316. The first and second planar walls 324, 328 are offset from one another at a non-zero angle A5. In the illustrated embodiment, the non-zero angle A5 is between 110 degrees and 140 degrees. Specifically, the non-zero angle A5 is 130 degrees. The rake face 316 defines a radius R5 between the adjacent walls 324, 328. In the illustrated embodiment, the radius R5 is between 0.1 millimeters and 0.5 millimeters. Specifically, the radius R5 is 0.3 millimeters.

The illustrated front wall 320 is a planar wall. The front wall 320 is connected to a bottom wall 332 at a corner having a radius R6. In the illustrated embodiment, the radius R6 is between 0.1 millimeters and 0.3 millimeters. Specifically, the radius R6 is 0.2 millimeters. The bottom wall 332 is connected to a corner wall 336 at a corner having a radius R7. In the illustrated embodiment, the radius R7 is between 0.1 millimeters and 0.2 millimeters. Specifically, the radius R7 is 0.15 millimeters. The corner wall 336 is coupled to a rear wall 340.

The insert 304 also includes a relief face 344, or top wall, that is connected to the rear wall 340 at a corner. The relief face 344 defines a non-zero angle A6 (e.g., a top angle clearance). In the illustrated embodiment, the non-zero angle A6 is between 8 degrees and 12 degrees. Specifically, the non-zero angle A6 is 10 degrees. The relief face 344 has a distance X2 that is measured from a rearward point of the relief face 344 to the relief surface 190 of the cutting tooth 132. In the illustrated embodiment, the distance X2 is between 0 millimeters and 0.2 millimeters. Specifically, the distance X2 is 0.1 millimeters.

The insert 304 includes a second front wall 348 between the cutting edge 312 and the rake face 316. In particular, the second front wall 348 extends from the cutting edge 312 to the first planar wall 324 of the rake face 316. In the illustrated embodiment, the second front wall 348 is parallel to the rea wall 340. The second front wall 348 defines a length L5. In the illustrated embodiment, the length L5 is between 0.1 millimeters and 0.5 millimeters. Specifically, the length L5 is 0.3 millimeters.

The insert 304 defines an axis 350 that is perpendicular to the wall 340 and intersects a bottom edge 352 of the insert 304. The axis 350 locates various features of the insert 304. An intersection point 356 defined between the front wall 320 and the second planar wall 328 of the rake face 316 is located at a distance X3 perpendicular to the axis 350. In the illustrated embodiment, the distance X3 is between 2.03 millimeters and 2.23 millimeters. Specifically, the distance X3 is 2.13 millimeters. A center point of the radius R5 is located at a distance X4 perpendicular to the axis 350. In the illustrated embodiment, the distance X4 is between 2.88 millimeters and 3.08 millimeters. Specifically, the distance X4 is 2.98 millimeters. The insert 304 defines a length L6 that is measured from the axis 350 to the cutting edge 312. In the illustrated embodiment, the length L6 is approximately 4.5 millimeters. The insert 304 defines a length L7 that is measured from the front wall 320 to the rear wall 340 along the axis 350. In the illustrated embodiment, the length L7 is between 2.6 millimeters and 3 millimeters. Specifically, the length L7 is 2.8 millimeters.

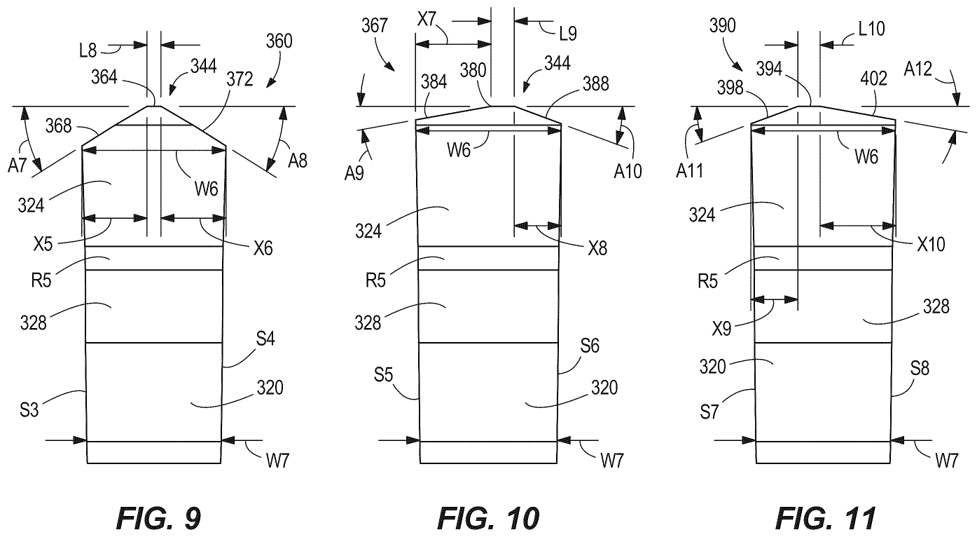

FIG. 9 illustrates an insert 360 of the plurality of inserts 304. The relief face 344 of the insert 360 has a chamfer that extends along both sides S3, S4 of the insert 304 and over at least half of a width of the insert 304. In particular, the relief face 344 includes a horizontal wall 364, a first chamfered wall 368, and a second chamfered wall 372. The horizontal wall 364 defines a length L8. In the illustrated embodiment, the length L8 is between 0.05 millimeters and 0.35 millimeters. Specifically, the length L8 is 0.2 millimeters. The horizontal wall 364 is disposed a distance X5 relative to a first side S3 of the insert 360. In the illustrated embodiment, the distance X5 is approximately 0.7 millimeters. The horizontal wall 364 is disposed a distance X6 relative to a second side S4 of the insert 360. In the illustrated embodiment, the distance X6 is approximately 0.7 millimeters. In the illustrated embodiment, the distances X5, X6 are identical in value. In other embodiments, the distances X5, X6 are different in value. The first chamfered wall 368 extends between the first side S3 of the insert 360 and the horizonal wall 364.

The first chamfered wall 368 is angled from the horizontal wall 364 at a non-zero angle A7. In the illustrated embodiment, the non-zero angle A7 is between 25 degrees and 35 degrees. Specifically, the non-zero angle A7 is 30 degrees. The second chamfered wall 372 extends between the second side S4 of the insert 360 and the horizonal wall 364. The second chamfered wall 372 is angled from the horizontal wall 364 at a non-zero angle A8. In the illustrated embodiment, the non-zero angle A8 is between 25 degrees and 35 degrees. Specifically, the non-zero angle A8 is 30 degrees. Together, the first chamfered wall 368 and the second chamfered wall 372 form the chamfer.

The insert 360 defines a width W6 proximal to the cutting edge 312. In the illustrated embodiment, the width W6 is between 1.4 millimeters and 2.1 millimeters. Specifically, the width W6 is 1.6 millimeters. In some embodiments, the width of the insert 360 is not uniform. For example, the width is tapered between the bottom wall 332 and the relief face 344. For instance, the insert 360 defines a width W7 that is proximal to the bottom wall 332. In other words, the width of the insert 360 decreases from the cutting edge 312 to the bottom wall 332. In the illustrated embodiment, the difference between the width W6 and the W7 is between 0.06 millimeters and 0.20 millimeters. In some embodiments, the width of the insert 360 is larger proximal to the bottom wall 332 relative to the relief face 344. In the configuration of the insert 360 illustrated in FIG. 9, a length of the first chamfered wall 368 is equal to a length of the second chamfered wall 372.

FIG. 10 illustrates an insert 376 of the plurality of inserts 304. The relief face 344 of the insert 376 includes a horizontal wall 380, a first chamfered wall 384, and a second chamfered wall 388. The horizontal wall 380 defines a length L9. In the illustrated embodiment, the length L9 is between 0.15 millimeters and 0.45 millimeters. Specifically, the length L9 is 0.3 millimeters. The horizontal wall 380 is disposed a distance X7 relative to a first side S5 of the insert 376. In the illustrated embodiment, the distance X7 is approximately 0.8 millimeters. The horizontal wall 380 is disposed a distance X8 relative to a second side S6 of the insert 376. In the illustrated embodiment, the distance X8 is approximately 0.5 millimeters. In some embodiments, the distances X7, X8 are identical in value. In the illustrated embodiment, the distances X7, X8 are different in value.

The first chamfered wall 384 extends between the first side S5 of the insert 376 and the horizonal wall 380. The first chamfered wall 384 is angled from the horizontal wall 380 at a non-zero angle A9. In the illustrated embodiment, the non-zero angle A9 is between 6 degrees and 14 degrees. Specifically, the non-zero angle A9 is 10 degrees. The second chamfered wall 388 extends between the second side S6 of the insert 376 and the horizontal wall. The second chamfered wall 388 is angled from the horizontal wall 380 at a non-zero angle A10. In the illustrated embodiment, the non-zero angle A10 is between 15 degrees and 25 degrees. Specifically, the non-zero angle A10 is 20 degrees. Together, the first chamfered wall 382 and the second chamfered wall 388 form the chamfer. In the configuration of the insert 376 illustrated in FIG. 10, a length of the first chamfered wall 384 is longer than a length of the second chamfered wall 388.

FIG. 11 illustrates an insert 390 of the plurality of inserts 304. The relief face 344 of the insert 390 includes a horizontal wall 394, a first chamfered wall 398, and a second chamfered wall 402. The horizontal wall 394 defines a length L10. In the illustrated embodiment, the length L10 is between 0.15 millimeters and 0.45 millimeters. Specifically, the length L10 is 0.3 millimeters. The horizontal wall 394 is disposed a distance X9 relative to a first side S7 of the insert 390. In the illustrated embodiment, the distance X9 is approximately 0.5 millimeters. The horizontal wall 394 is disposed a distance X10 relative to a second side S8 of the insert 390. In the illustrated embodiment, the distance X10 is approximately 0.8 millimeters. In the illustrated embodiment, the distances X9, X10 are different in value. In some embodiments, the distances X9, X10 are identical in value.

The first chamfered wall 398 extends between the first side S7 of the insert 390 and the horizontal wall 394. The first chamfered wall 398 is angled from the horizontal wall 394 at a non-zero angle A11. In the illustrated embodiment, the non-zero angle A11 is between 15 degrees and 25 degrees. Specifically, the non-zero angle A11 is 20 degrees. The second chamfered wall 402 extends between the second side S8 of the insert 390 and the horizonal wall 394. The second chamfered wall 402 is angled from the horizontal wall 394 at a non-zero angle A12. In the illustrated embodiment, the non-zero angle A12 is between 6 degrees and 14 degrees. Specifically, the non-zero angle A12 is 10 degrees. Together, the first chamfered wall 298 and the second chamfered wall 394 form the chamfer. In the configuration of the insert 390 illustrated in FIG. 11, a length of the first chamfered wall 398 is shorter than a length of the second chamfered wall 402.

A difference between the insert 376 and the insert 390 is the position of horizonal wall (e.g., horizontal walls 380, 394) and the chamfered walls (e.g., walls 384, 388, 398, and 402) relative to the first side S1 of the body 104 (or the insert 376, 390) and the second side S2 of the body 104 (or the insert 376, 390). For instance, the horizontal wall 380 is closer to the first side S1 than the second side S2 for the insert 376. In contrast, the horizontal wall 394 is closer to the second side S2 than the first side S1 for the insert 390.

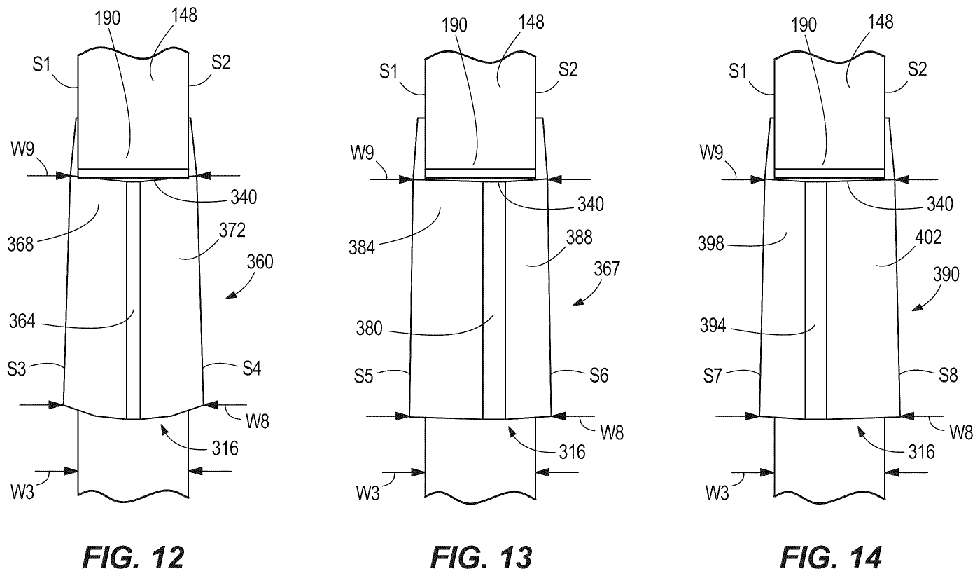

FIG. 12 illustrates the insert 360 defining a width W8 proximal to the rake face 316 and defining a width W9 proximal to the rear wall 340. In the illustrated embodiment, the width W8 is between 1.2 millimeters and 1.8 millimeters. Specifically, the width W8 is 1.5 millimeters. The difference between the widths W8, W9 is between 0.06 millimeters and 0.16 millimeters. In other words, the width of the insert 360 is tapered between the rake face 316 and the rear wall 340, or the width of the insert 360 is tapered as it extends away from the cutting edge 312. FIG. 13 illustrates that the insert 376 is also tapered from the rake face 316 to the rear wall 340. FIG. 14 illustrates that the insert 390 is also tapered from the rake face 316 to the rear wall 340. In the illustrated embodiment, the difference in widths W8 and W9 of the inserts 360, 376, 390 are the same in value. In some embodiments, the difference in widths W8 and W9 of the inserts 360, 376, 390 are different in value.

Referring back to FIG. 7, the plurality of inserts 304 is a collection of the inserts 360, 376, 390. In the illustrated embodiment, the plurality of inserts 304 is a repeating pattern of inserts 360, 376, 390. In other embodiments, the inserts 304 may be arranged in any repeating or non-repeating patterns about a circumference of the saw blade 300.

In some embodiments, the saw blades 100, 300 include a coating 500. In some embodiments, the coating 500 is a thin film ceramic coating overlaying at least the plurality of inserts 140, 304. In some embodiments, the coating 500 may be disposed on a portion of the teeth of the blades 100, 300. In some embodiments, the coating 500 may be disposed on the entirety of each tooth of the cutting teeth 132. In some embodiments, the coating 500 may be disposed on the entire saw blade of the saw blades 100, 300. In some embodiments, the coating 500 is applied to the inserts 140, 304 of the saw blades 100, 300, respectively.

In some embodiments, the coating 500 is composed of aluminum titanium nitride (AlTiN). The AlTiN coating increases oxidation resistance at elevated temperatures due to the formation of a protective aluminium-oxide layer at the surface. In addition, the AlTiN coating increases hardness in deposited films due to micro-structure changes and solid solution hardening. Further, the AlTiN coating age hardens at temperatures typical during operation of the saw blades 100, 300. In other embodiments, the coating 500 is composed of aluminum chromium nitride (AlCrN). The AlCrN coating includes a high hot hardness with high wear resistance in extreme mechanical stresses. The AlCrN coating is particularly beneficial at high speed applications, such as those experienced by the saw blades 100, 300. In further embodiments, the coating 500 is composed of aluminum titanium chromium nitride (AlTiCrN). The AlTiCrN coating includes a high hardness, toughness, and oxidation temperature. The AlTiCrN coating is particularly beneficial for machining hardened steels, stainless steels, superalloys, and other difficult to machine materials. Still, in other embodiments, the coating 500 is composed of a titanium-based material. For example, the coating 500 is composed of titanium molybdenum nitride (TiMoN). The TiMoN coating is a ceramic material.

In some embodiments, the coating 500 may be applied via physical vapor deposition (PVD), which is a variety of vacuum deposition methods. PVD is a process in which a material, such as the coating 500, goes from a condensed phase to a vapor phase, and subsequently back to a thin film condensed phase, producing a thin film or coating. In some embodiments, the PVD process may include evaporation, in which vapor particles of the coating 500 travel directly to the substrate, where the particles condense back to a solid state. In other embodiments, the PVD process may include sputtering, in which a thin film is deposited from a source onto the substrate. In further embodiments, the coating 500 may be applied via additional methods such as hot-dip galvanizing, thermal spraying, electroplating, sherardizing, and the like.

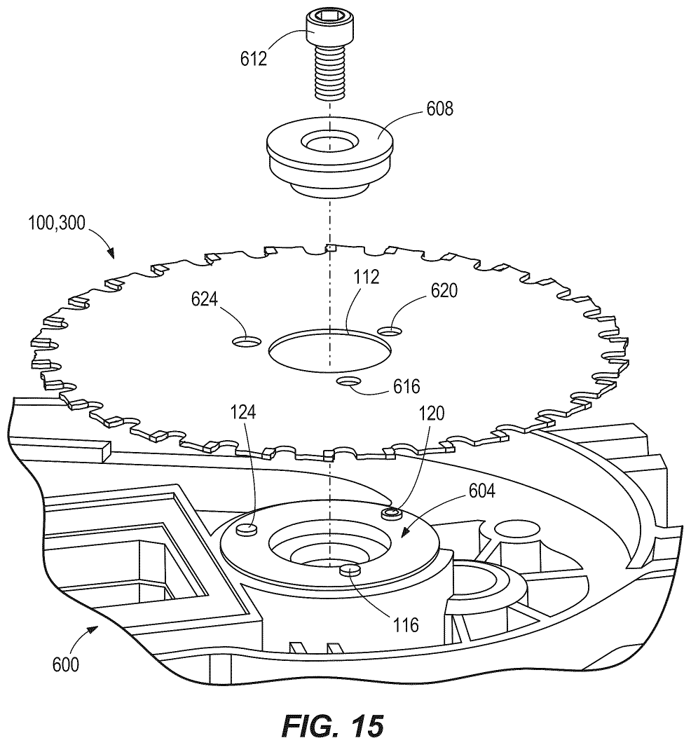

FIG. 15 illustrates a saw blade, such as one of the saw blades 100, 300, coupled to a tool 600. The tool 600 may be a power tool having a motor, a drive mechanism, and a power source (e.g., a battery pack). In other embodiments, the tool 600 may be a non-powered tool. The illustrated tool 600 is a powered rebar cutter and an output shaft 604 configured to receive the saw blade 100, 300. The output shaft 604 operably couples the saw blade 100, 300 to the motor of the tool 600 to drive (e.g., rotate) the saw blade 100, 300. In the illustrated embodiment, the output shaft 604 includes a blade flange 608 and a fastener 612 (e.g., a bolt, a screw, etc.) to secure the saw blade 100, 300 to the tool 600. The blade flange 608 is received in the bore 112 of the saw blade 100, 300. In other embodiments, the output shaft 604 may have other configurations.

The illustrated tool 600 also includes a plurality of alignment protrusions 616, 620, 624. In the illustrated embodiment, the tool 600 includes three alignment protrusions 616, 620, 624 corresponding to the three apertures 116, 120, 124 of the saw blade 100, 300. In particular, the first alignment protrusion 616 is shaped and sized to fit in the first aperture 116, the second alignment protrusion 620 is shaped and sized to fit in the second aperture 120, and the third alignment protrusion 624 is shaped and sized to fit in the third aperture 124. The alignment protrusions 616, 620, 624 help align the saw blade 100, 300 on the tool 600 and with the output shaft 604. The alignment protrusions 616, 620, 624 may also help drive (e.g., rotate) the saw blade 100, 300. In the illustrated embodiment, the alignment protrusions 616, 620, 624 are coupled to and extend from the output shaft 604. In other embodiments, the alignment protrusions 616, 620, 624 may be located elsewhere on the tool 600.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A saw blade comprising:
a body having a center and a circumferential edge;
an arbor disposed at the center of the body, the arbor defining a first aperture, a second aperture, and a third aperture circumferentially spaced from each other about the center of the body and configured to receive alignment protrusions of a tool, the first aperture having a first diameter, the second aperture having a second diameter that is different than the first diameter;
a bore formed in the arbor between the first aperture, the second aperture, and the third aperture, the bore configured to receive an output shaft of the tool; and
a cutting edge extending from the circumferential edge of the body.

2. The saw blade of claim 1, wherein the third aperture has a third diameter that is different than the second diameter.

3. The saw blade of claim 2, wherein the third diameter is the same as the first diameter.

4. The saw blade of claim 3, wherein the second diameter is greater than the first diameter.

5. The saw blade of claim 1, wherein the first diameter is between 3 millimeters and 8 millimeters, and wherein the second diameter is between 4 mm and 9 mm.

6. The saw blade of claim 5, wherein the bore has a diameter between 25 mm and 31 mm.

7. The saw blade of claim 1, wherein the bore has a diameter that is greater than the first diameter and that is greater than the second diameter.

8. The saw blade of claim 7, wherein a ratio of the diameter of the bore to the first diameter is between 3 and 10.5, and wherein a ratio of the diameter of the bore to the second diameter is between 2.5 and 8.

9. The saw blade of claim 1, wherein the first aperture, the second aperture, and the third aperture are equally circumferentially spaced from each other.

10. The saw blade of claim 1, wherein the first aperture is spaced a first radial distance from the center of the body, and wherein the second aperture is spaced a second radial distance from the center of the body that is different than the first radial distance.

11. The saw blade of claim 10, wherein the third aperture is spaced a third radial distance from the center of the body that is different than the first radial distance.

12. The saw blade of claim 11, wherein the third radial distance is the same as the second radial distance.

13. The saw blade of claim 1, wherein:
the first aperture is spaced a first radial distance from the center of the body,
the second aperture is spaced a second radial distance from the center of the body that is different than the first radial distance,
the third aperture has a third diameter and is spaced a third radial distance from the center of the body,
the third diameter is the same as the first diameter, and
the third radial distance is the same as the second radial distance.

14. A saw blade comprising:
a body constructed of a first material and having a center and a circumferential edge;
an arbor disposed at the center of the body;
a bore formed in the arbor, the bore configured to receive an output shaft of a tool;
a plurality of cutting teeth extending from the circumferential edge of the body; and
a plurality of inserts coupled to the plurality of cutting teeth, each insert constructed of a second material that is different than the first material and including
a first side and a second side opposite the first side, the first and second sides defining a width of the insert,
a cutting edge extending between the first and second sides,
a rake face adjacent the cutting edge, the rake face defining a notch in the insert,
a planar wall extending from the rake face toward the body, and
a relief face extending from the cutting edge, the relief face having a chamfer that extends along at least one of the first and second sides and over at least half of the width of the insert.

15. The saw blade of claim 14, wherein the rake face of at least some inserts includes a curved wall and a planar wall that define the notch.

16. The saw blade of claim 14, wherein the rake face of at least some inserts includes a first planar wall and a second planar wall that define the notch.

17. The saw blade of claim 14, wherein the chamfer of at least some inserts is formed by a single chamfered wall extending from a horizontal wall.

18. The saw blade of claim 14, wherein the chamfer of at least some inserts is formed by a first chamfered wall and a second chamfered wall extending in opposite directions from a horizontal wall.

19. The saw blade of claim 14, wherein the first and second sides of at least some inserts taper toward each other as the first and second sides extend away from the cutting edge.

20. A saw blade comprising:
a body constructed of a first material and having a center and a circumferential edge;
an arbor disposed at the center of the body;
a bore formed in the arbor, the bore configured to receive an output shaft of a tool;
a plurality of cutting teeth extending from the circumferential edge of the body; and
a plurality of inserts coupled to the plurality of cutting teeth, each insert constructed of a second material that is different than the first material and including
a first side and a second side opposite the first side,
a cutting edge extending between the first and second sides,
a rake face adjacent the cutting edge, the rake face defining a notch in the insert,
a planar wall extending from the rake face toward the body, and
a relief face extending from the cutting edge;
wherein the cutting edges of the plurality of inserts collectively define a cutting diameter of the saw blade that is between 135 millimeters and 139 millimeters.
